(19) United States
(12) Patent Application Publication
(10) Pub. No.: US 2024/0027069 A1
(43) Pub. Date: Jan. 25, 2024

(54) COMBUSTOR FOR GAS TURBINE AND GAS TURBINE

(71) Applicant: MITSUBISHI HEAVY INDUSTRIES, LTD., Tokyo (JP)

(72) Inventors: Shinichi Fukuba, Tokyo (JP); Satoshi Takiguchi, Tokyo (JP); Taiki Kinoshita, Kanagawa (JP); Kenta Taniguchi, Kanagawa (JP); Sosuke Nakamura, Kanagawa (JP); Yoshikazu Matsumura, Kanagawa (JP)

(73) Assignee: MITSUBISHI HEAVY INDUSTRIES, LTD., Tokyo (JP)

(21) Appl. No.: 17/914,694

(22) PCT Filed: Mar. 31, 2021
(86) PCT No.: PCT/JP2021/013809

§ 371 Date: Sep. 26, 2022

(30) Foreign Application Priority Data
Mar. 31, 2020 (JP) 2020-063062

(51) Int. Cl. F23R 3/34; F23R 3/12

(52) U.S. Cl. CPC F23R 3/343; F23R 3/12

(57) ABSTRACT

A combustor for a gas turbine, includes: a first fuel nozzle group and a second fuel nozzle group each of which includes a fuel nozzle capable of supplying a fuel and has an independently controllable fuel supply system; a cylinder inside which a combustion region allowing a combustion gas produced by combustion of the fuel to flow is formed; and a first contraction portion extending partially along a circumferential direction so as to correspond to one of the first fuel nozzle group or the second fuel nozzle group and protruding radially inward from an inner peripheral surface of the cylinder.

### TECHNICAL FIELD

The present disclosure relates to a combustor for a gas turbine and a gas turbine.

### BACKGROUND

A combustor used in a gas turbine includes, for example, a fuel nozzle capable of supplying fuel, and a cylinder inside which a combustion region allowing a combustion gas produced by combustion of the fuel to flow is formed. The fuel supplied from the fuel nozzle becomes fuel gas by combustion and drives a turbine disposed downstream via the combustion region of the cylinder.

In this type of gas turbine combustor, the temperature of the combustion gas in the vicinity of the inner wall surface of the cylinder is lower than that in the central portion, so that the timing of chemical reaction in which carbon monoxide (CO) contained in the combustion gas is converted into carbon dioxide (CO₂) may be delayed, and carbon monoxide may increase. To solve this problem, Patent Document 1 discloses that a contraction member is provided on the inner wall surface of the cylinder of the combustor to cause the combustion gas in the vicinity of the inner wall surface to flow toward the central portion so as to be mixed with the hot combustion gas in order to promote combustion and suppress the generation of carbon monoxide.

### CITATION LIST

### Patent Literature

Patent Document 1: WO2011/058931A

### SUMMARY

### Problems to be Solved

In a gas turbine combustor, combustion oscillation may occur due to interaction between pressure fluctuation and heat generation due to fuel combustion during partial load operation in which the operating load is lower than in rated operation. In order to prevent such combustion oscillation, it is conceivable to, for example, classify a plurality of fuel nozzles of the gas turbine combustor into a group with large fuel injection amount and a group with small fuel injection amount and arrange them asymmetrically. However, in the fuel nozzles belonging to the group with small fuel injection amount, the temperature of the combustion gas becomes relatively low, so that the area of a flame formed by the injected fuel expands to the downstream side, resulting in an increase in carbon monoxide emissions. At least one aspect of the present disclosure was made in view of the above

circumstances, and an object thereof is to provide a combustor for a gas turbine and a gas turbine that can suitably suppress the generation of carbon monoxide while preventing combustion oscillation during partial load operation.

### Solution to the Problems

To solve the above problem, a combustor for a gas turbine according to one aspect of the present disclosure includes: a first fuel nozzle group and a second fuel nozzle group each of which includes a fuel nozzle capable of supplying a fuel and has an independently controllable fuel supply system; a cylinder inside which a combustion region allowing a combustion gas produced by combustion of the fuel to flow is formed; and a first contraction portion extending partially along a circumferential direction so as to correspond to one of the first fuel nozzle group or the second fuel nozzle group and protruding radially inward from an inner peripheral surface of the cylinder.

### Advantageous Effects

At least one aspect of the present disclosure provides a combustor for a gas turbine and a gas turbine that can suitably suppress the generation of carbon monoxide while preventing combustion oscillation during partial load operation.

### BRIEF DESCRIPTION OF DRAWINGS

FIG. 1 is an overall configuration diagram of a gas turbine according to at least one embodiment of the present disclosure.

FIG. 2 is a cross-sectional view of the combustor of FIG. 1 shown together with the surrounding configuration.

FIG. 3 is an enlarged view of region L of FIG. 2.

FIG. 4 is a schematic diagram of the fuel nozzles of FIG. 3 viewed from the downstream side along the combustor axis.

FIG. 5 is a cross-sectional view schematically showing a flame formed in a cylinder during partial load operation in a combustor according to a comparative example.

FIG. 6 is a diagram showing distributions of temperature and carbon monoxide concentration on the dashed line in FIG. 5.

FIG. 7 is a cross-sectional view schematically showing a flame formed in a cylinder during partial load operation in a combustor according to some embodiments of the present disclosure.

FIG. 8 is an enlarged view of the first contraction portion of FIG. 7, viewed from the side.

FIG. 9 is a perspective view of the first contraction portion of FIG. 7 extracted alone.

FIG. 10 is a diagram showing distributions of temperature and carbon monoxide concentration corresponding to FIG. 7.

FIG. 11 is a diagram showing an example of the first contraction portion including a grooved contraction piece.

FIG. 12 is a diagram showing the grooved contraction piece of FIG. 11 together with the flow of combustion gas from the radially inner side.

FIG. 13 is a modified example of FIG. 7.

FIG. 14 is a side view of the cylinder with the first contraction portion and the second contraction portion of FIG. 13 transparently shown.

FIG. 15 is a schematic diagram of the fuel nozzles of FIG. 13 viewed from the downstream side along the combustor axis.

FIG. 16 is a diagram showing distributions of temperature and carbon monoxide concentration corresponding to FIG. 13.

FIG. 17 is a diagram showing an example of the second contraction portion including a grooved contraction piece.

FIG. 18 is a diagram showing the grooved contraction piece of FIG. 17 together with the flow of combustion gas from the radially inner side.

### DETAILED DESCRIPTION

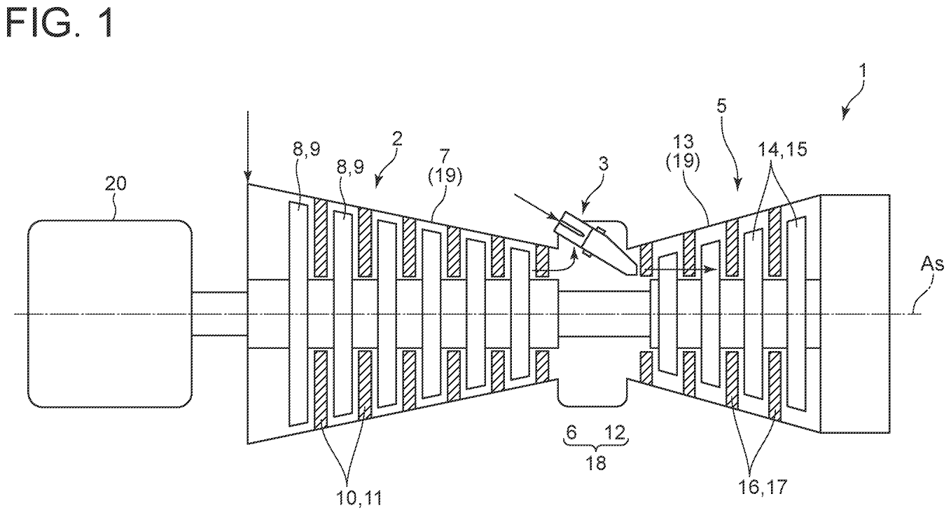

Embodiments of the present invention will now be described in detail with reference to the accompanying drawings. It is intended, however, that unless particularly identified, dimensions, materials, shapes, relative positions, and the like of components described in the embodiments shall be interpreted as illustrative only and not intended to limit the scope of the present invention. FIG. 1 is an overall configuration diagram of a gas turbine 1 according to at least

one embodiment of the present disclosure. The gas turbine 1 includes a compressor 2, a combustor 3, and a turbine 5.

The compressor 2 has a compressor rotor 6 extending along the axis As, and a compressor casing 7 that covers the compressor rotor 6 from the outer peripheral side. The compressor rotor 6 has a columnar shape centered on the axis As, with compressor rotor blades 8 attached to the outer peripheral surface thereof. Multiple compressor rotor blades 8 are arranged at intervals in the circumferential direction about the axis As to constitute a compressor rotor blade stage 9. On the compressor rotor 6, multiple compressor rotor blade stages 9 are arranged in rows at intervals in the axis As direction.

On the inner peripheral side of the compressor casing 7, compressor stator vane stages 11 are arranged in rows so as to alternate with the compressor rotor blades 8 in the axis As direction. Each compressor stator vane stage 11 is composed of multiple compressor stator vanes 10 arranged at intervals in the circumferential direction about the axis As so as to correspond to the compressor rotor blade stage 9.

The combustor 3 is a gas turbine combustor according to at least one embodiment of the present disclosure and produces a combustion gas having high temperature and high pressure by mixing the high-pressure air generated by the compressor 2 with the fuel and combusting the mixture. The combustion gas is supplied to the turbine 5, which will be described later, to drive the turbine 5. The configuration of the combustor 3 will be described later in detail.

The turbine 5 is a gas turbine driven by the combustion gas produced by the combustor 3, and has a turbine rotor 12 extending along the axis As and a turbine casing 13 that covers the turbine rotor 12 from the outer peripheral side. The turbine rotor 12 has a columnar shape centered on the axis As, with turbine rotor blades 14 attached to the outer peripheral surface thereof. Multiple turbine rotor blades 14 are arranged at intervals in the circumferential direction about the axis As to form a turbine rotor blade stage 15. On the turbine rotor 12, multiple turbine rotor blade stages 15 are arranged in rows at intervals in the axis As direction.

On the inner peripheral side of the turbine casing 13, turbine stator vane stages 17 are arranged in rows so as to alternate with the turbine rotor blades 14 in the axis As direction. Each turbine stator vane stage 17 is composed of multiple turbine stator vanes 16 arranged at intervals in the circumferential direction about the axis As.

The compressor rotor 6 and the turbine rotor 12 are located on the same axis (axis As) and are connected to each other to form a gas turbine rotor 18. The shaft end of the gas turbine rotor 18 is connected to a generator 20, for example. Further, the compressor casing 7 and the turbine casing 13 are connected to each other to constitute a gas turbine casing 19.

In the gas turbine 1 having the above configuration, as the compressor rotor 6 rotates, the compressor 2 generates high-pressure air. The high-pressure air is guided to the combustor 3 and burned together with fuel to produce a combustion gas having high temperature and high pressure. Then, when the combustion gas is introduced to the turbine 5, the combustion gas sequentially impinges on the turbine rotor blades 14 and the turbine stator vanes 16 to impart kinetic energy to the turbine rotor 12 (gas turbine rotor 18). The kinetic energy thus given rotates the gas turbine rotor 18 around the axis As. The rotation of the gas turbine rotor 18 is transmitted to the generator 20 connected to the shaft end of the gas turbine rotor 18 and is used to generate power, for example.

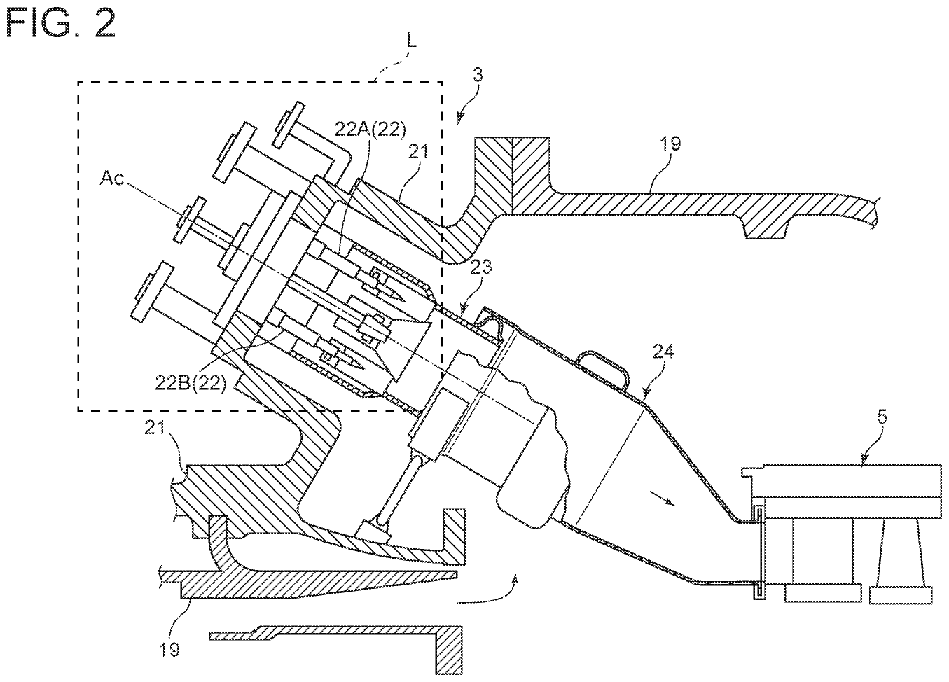

FIG. 2 is a cross-sectional view of the combustor 3 of FIG. 1 shown together with the surrounding configuration. The combustor 3 includes a combustor casing 21 supported by the gas turbine casing 19, a fuel nozzle 22 supported by the combustor casing 21 and capable of supplying fuel, a swirler support pipe 23 that covers the fuel nozzle 22 from the outside, and a cylinder 24 (combustion liner) connected to the downstream side of the swirler support pipe 23.

The fuel injected from the fuel nozzle 22 is mixed with the compressed air inside the swirler support pipe and supplied into the cylinder 24. The swirler support pipe 23 has a cylindrical shape centered on the combustor axis Ac. The combustor axis Ac extends in a direction intersecting the axis As (see FIG. 1). The intersection angle between the axis As and the combustor axis Ac is set to an acute angle (less than 90 degrees). The downstream end of the swirler support pipe 23 is connected to the cylinder 24. The fuel supplied from the fuel nozzle 22 is mixed with the compressed air supplied from the compressor 2 in the combustion region in the cylinder 24 and then combusted to produce a combustion gas. The combustion gas is supplied to the turbine 5 via the cylinder 24.

The expressions such as upstream, downstream, upstream side, and downstream side used in the following description are based on the flow direction of the combustion gas flowing inside the cylinder 24. That is, the side on which the fuel nozzle 22 is disposed with respect to the cylinder 24 is referred to as upstream side, and the side on which the cylinder 24 is disposed with respect to the fuel nozzle 22 is referred to as downstream side. The flow direction of the combustion gas means a direction along the direction of the combustor axis Ac. Further, the flow of the combustion gas flowing in the swirler support pipe 23 and the cylinder 24 is appropriately referred to as “mainstream”.

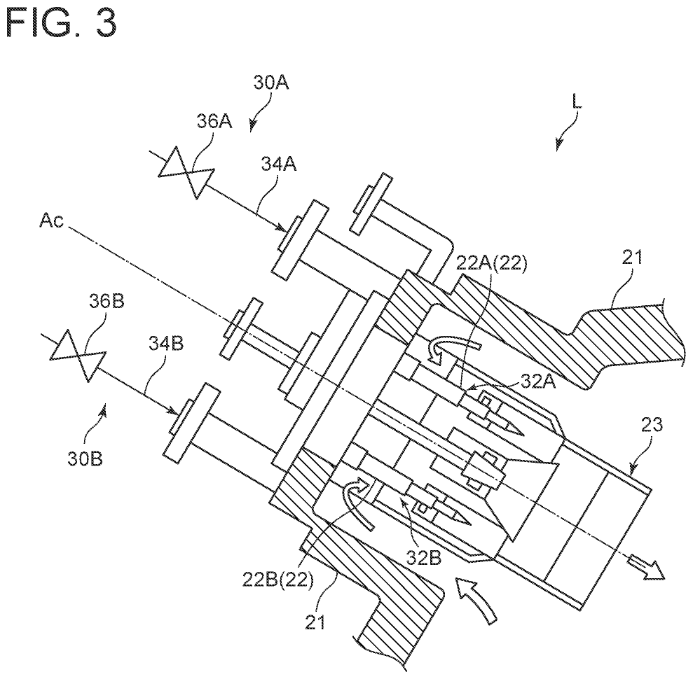

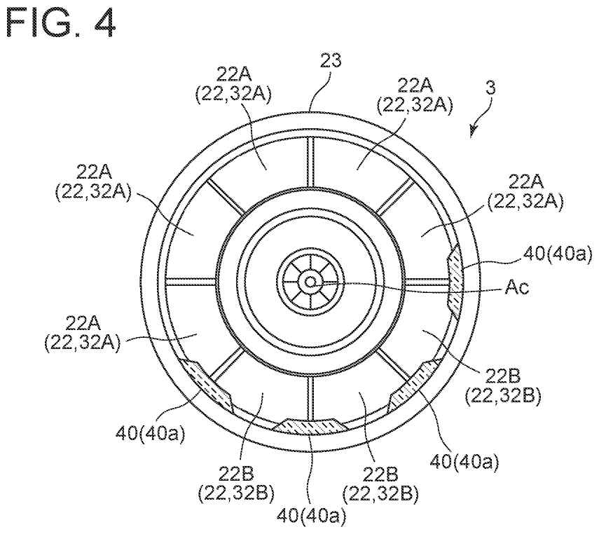

FIG. 3 is an enlarged view of region L of FIG. 2. FIG. 4 is a schematic diagram of the fuel nozzles 22 of FIG. 3 viewed from the downstream side along the combustor axis Ac. The plurality of fuel nozzles 22 of the combustor 3 includes a plurality of fuel nozzle groups that can be controlled independently of each other. Specifically, the plurality of fuel nozzles 22 includes a first fuel nozzle group 32A having a first fuel supply system 30A and a second fuel nozzle group 32B having a second fuel supply system 30B. In FIGS. 3 and 4, the fuel nozzles 22 belonging to the first fuel nozzle group 32A are indicated by reference numeral 22A, and the fuel nozzles 22 belonging to the second fuel nozzle group 32B are indicated by reference numeral 22B.

Further, in FIG. 3, for clarity of illustration, the first fuel supply system 30A connected to one fuel nozzle 22 belonging to the first fuel nozzle group 32A and the second fuel supply system 30B connected to one fuel nozzle 22 belonging to the second fuel nozzle group 32B are representatively shown (The other fuel nozzles 22 not shown in FIG. 3 have the same configuration as the fuel nozzles 22 shown in FIG. 3 unless otherwise specified).

The first fuel supply system 30A has a first fuel supply passage 34A connected to the fuel nozzle 22A belonging to the first fuel nozzle group 32A, and a first fuel flow-rate adjustment valve 36A disposed in the first fuel supply passage 34A. The first fuel flow-rate adjustment valve 36A is a valve device capable of adjusting the flow rate of fuel supplied to the fuel nozzle 22A belonging to the first fuel nozzle group 32A through the first fuel supply passage 34A by adjusting the opening degree. The second fuel supply system 30B has a second fuel supply passage 34B connected to the fuel nozzle 22B belonging to the second fuel nozzle group 32B, and a second fuel flow-rate adjustment valve 36B disposed in the second fuel supply passage 34B. The second fuel flow-rate adjustment valve 36B is a valve device capable of adjusting the flow rate of fuel supplied to the fuel nozzle 22B belonging to the second fuel nozzle group 32B through the second fuel supply passage 34B by adjusting the opening degree.

The opening degrees of the first fuel flow-rate adjustment valve 36A and the second fuel flow-rate adjustment valve 36B can be controlled independently of each other in response to control signals from a control unit (not shown). Thus, the fuel nozzle 22A belonging to the first fuel nozzle group 32A and the fuel nozzle 22B belonging to the second fuel nozzle group 32B are configured so that the fuel supply amount can be controlled independently. Thus, for example, during partial load operation in which the output of the gas turbine 1 is smaller than the rated output, by making the fuel supply amount of the fuel nozzle 22A belonging to the first fuel nozzle group 32A different from the fuel supply amount of the fuel nozzle 22B belonging to the second fuel nozzle group 32B, it is possible to prevent combustion oscillation which is likely to occur during partial load operation. In the present embodiment, during partial load operation, the fuel supply amount of the fuel nozzle 22A belonging to the first fuel nozzle group 32A is controlled to be larger than that of the fuel nozzle 22B belonging to the second fuel nozzle group 32B.

The number of fuel nozzles 22A belonging to the first fuel nozzle group 32A and the number of fuel nozzles 22B belonging to the second fuel nozzle group 32B may be set to be different from each other. As shown in FIG. 4, the combustor 3 according to the present embodiment includes eight fuel nozzles 22 in total. Of the eight fuel nozzles 22, five belong to the first fuel nozzle group 32A, and the remaining three belong to the second fuel nozzle group 32B. During partial load operation, as described above, the fuel supply amount of the fuel nozzle 22A belonging to the first fuel nozzle group 32A and the fuel supply amount of the fuel nozzle 22B belonging to the second fuel nozzle group 32B are controlled so as to be different from each other. In addition to this, by making the number of fuel nozzles 22A belonging to the first fuel nozzle group 32A different from the number of fuel nozzles 22B belonging to the second fuel nozzle group 32B, it is possible to prevent combustion oscillation more effectively.

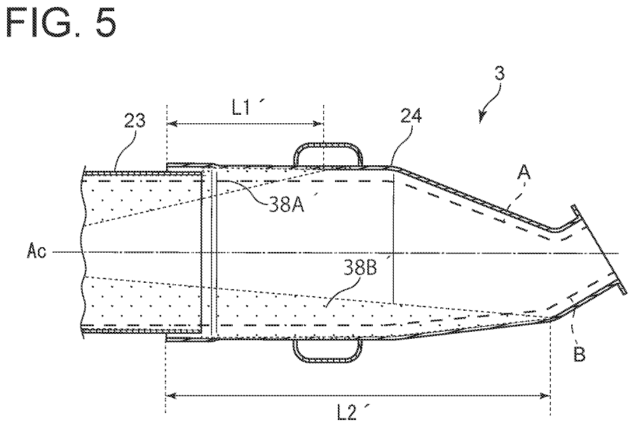

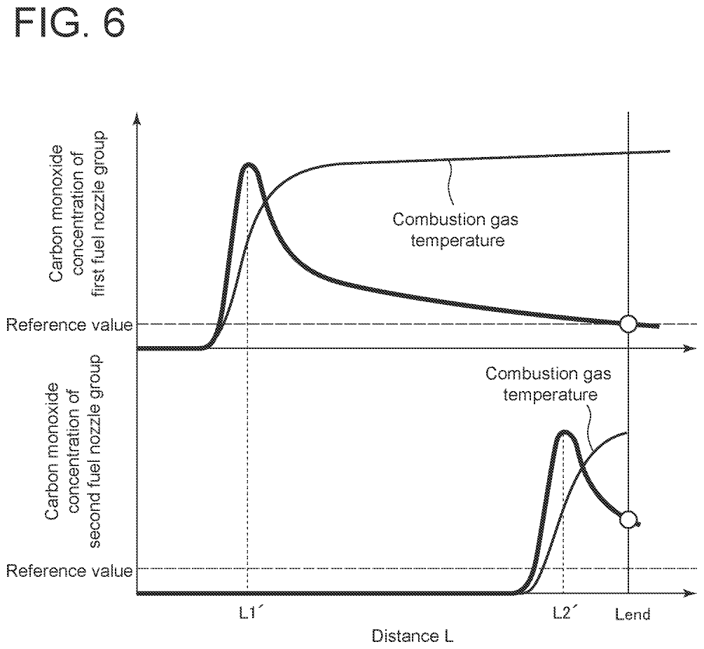

Here, the combustor 3 according to the present embodiment is provided with a first contraction portion 40 on the inner peripheral surface of the cylinder 24 downstream of the fuel nozzle 22 as will be described below, but first, a comparative example without the first contraction portion 40 will be described for comparison. FIG. 5 is a cross-sectional view schematically showing a flame formed in a cylinder 24 during partial load operation in a combustor 3′ according to a comparative example. FIG. 6 is a diagram showing distributions of temperature and carbon monoxide concentration on the dashed line in FIG. 5 (The upper part of FIG. 6 shows distributions of temperature and carbon monoxide concentration along the dashed line A of FIG. 5, and the lower part of FIG. 6 shows distributions of temperature and carbon monoxide concentration along the dashed line B of FIG. 6).

Inside the cylinder 24, a flame is formed by combustion of fuel supplied from the fuel nozzle 22 disposed upstream of the combustion region. FIG. 5 shows a first flame 38A′ formed by the fuel nozzle 22A belonging to the first fuel nozzle group 32A and a second flame 38B′ formed by the fuel nozzle 22B belonging to the second fuel nozzle group 32B. During partial load operation, as described above, in order to prevent the occurrence of combustion oscillation, the fuel supply amount of the fuel nozzle 22A belonging to the first fuel nozzle group 32A is controlled to be larger than that of the fuel nozzle 22B belonging to the second fuel nozzle group 32B. Accordingly, the first flame 38A′ has relatively high temperature of the combustion gas and is formed over a distance L1′ from the upstream end of the cylinder 24. Further, the concentration of carbon monoxide contained in the combustion gas peaks on the relatively upstream side of the cylinder 24 corresponding to the distance L1′ and then decreases downstream to satisfy a reference value at the downstream end L_{end} of the cylinder 24. This indicates that, since the first flame 38A′ corresponding to the first fuel nozzle group 32A has relatively high temperature of the combustion gas, carbon monoxide generated by combustion is sufficiently oxidized, converted into carbon dioxide through chemical reaction, and thus consumed in the course of passing through the combustion region of the cylinder 24.

On the other hand, the second flame 38B′ has relatively low temperature of the combustion gas and is formed over a wide range of distance L2′ to the downstream side of the first flame 38A′ (L2′>L1′). Further, the concentration of carbon monoxide contained in the combustion gas peaks on the relatively downstream side of the cylinder 24 corresponding to the distance L2′ and has a high value exceeding the reference value at the downstream end L_{end} of the cylinder 24. Therefore, in order to reduce the concentration of carbon monoxide at the downstream end L_{end} below the reference value, the load during partial load operation has to be relatively large, and thus it is difficult to obtain good turndown performance (low load operation performance).

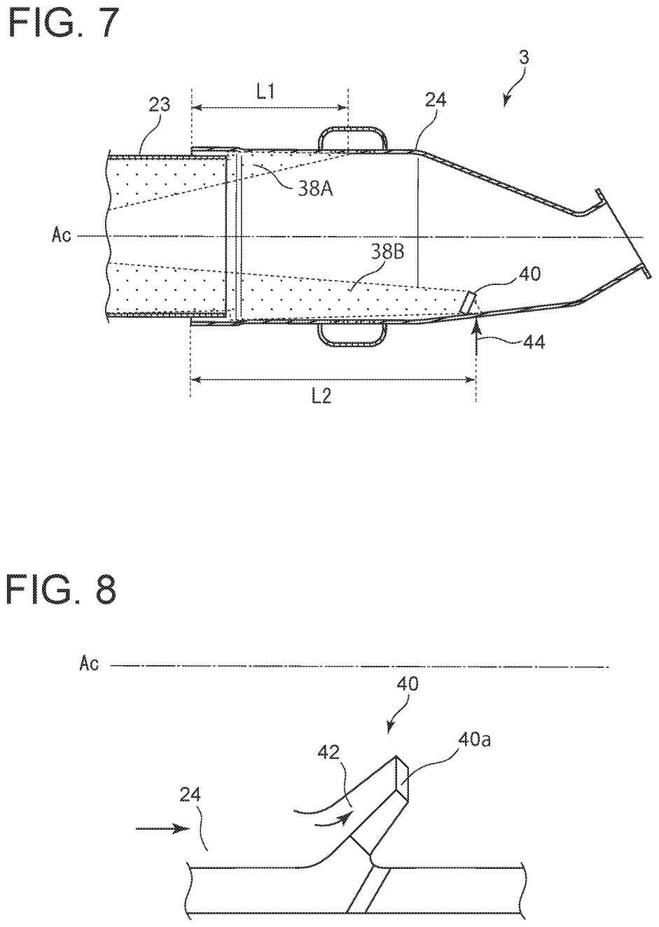

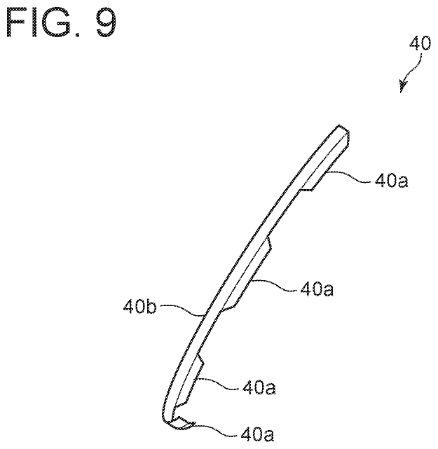

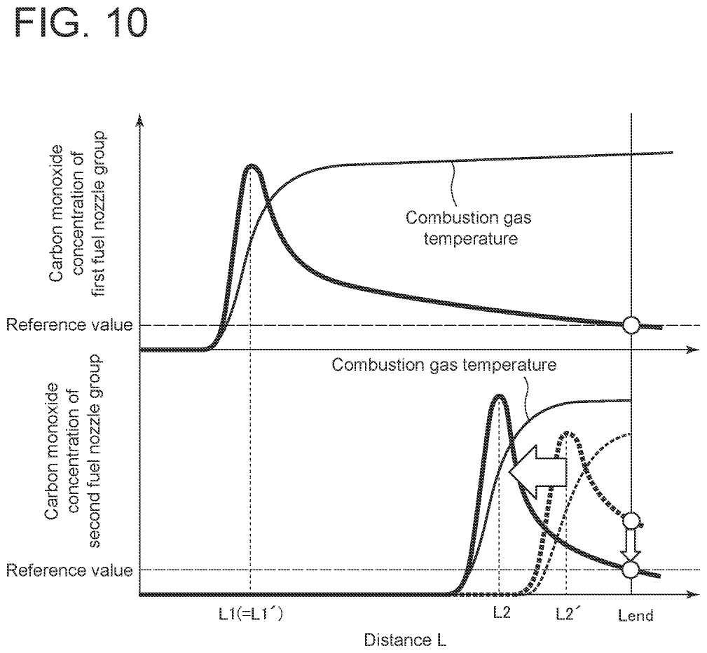

As will be described below, such a problem can be solved by providing the first contraction portion 40 on the inner peripheral surface of the cylinder 24 disposed downstream of the fuel nozzle 22. FIG. 7 is a cross-sectional view schematically showing a flame formed in the cylinder 24 during partial load operation in the combustor 3 according to some embodiments of the present disclosure. FIG. 8 is an enlarged view of the first contraction portion 40 of FIG. 7, viewed from the side. FIG. 9 is a perspective view of the first contraction portion 40 of FIG. 7 extracted alone. FIG. 10 is a diagram showing distributions of temperature and carbon monoxide concentration corresponding to FIG. 7.

The combustor 3 has a first contraction portion 40 extending along the circumferential direction so as to correspond to one of the first fuel nozzle group 32A or the second fuel nozzle group 32B. In the present embodiment, the first contraction portion 40 is disposed so as to correspond to the second fuel nozzle group 32B which is controlled to have smaller fuel supply amount during partial load operation. In the example shown in FIG. 4, the first contraction portion 40 is disposed in a range overlapping the arrangement region of each fuel nozzle 22B belonging to the second fuel nozzle group 32B when viewed from the downstream side along the combustor axis Ac. With this configuration, at least part of the combustion gas produced by combustion of fuel supplied from each fuel nozzle 22B belonging to the second fuel nozzle group 32B impinges on the first contraction portion 40.

When the combustion gas flowing inside the cylinder 24 has a swirl component around the combustor axis Ac, the range of the first contraction portion 40 may be provided with a predetermined phase difference with respect to the arrangement region of each fuel nozzle 22B belonging to the second fuel nozzle group 32B.

The first contraction portion 40 is formed so as to protrude radially inward from the inner peripheral surface of the cylinder 24. More specifically, as shown in FIG. 8, the first contraction portion 40 has a receiving surface 42 formed obliquely to the combustor axis Ac so as to receive the combustion gas flowing from upstream to downstream inside the cylinder 24. When the combustor 3 has such a first contraction portion 40, the combustion gas of the fuel from the fuel nozzle 22B belonging to the second fuel nozzle group 32B is deflected by the receiving surface 42 of the first contraction portion 40 toward the radially inner side of the cylinder 24 with relatively high temperature.

Thus, as shown in FIG. 10, the temperature of the combustion gas of the fuel from the fuel nozzle 22B belonging to the second fuel nozzle group 32B rises at the position L2 corresponding to the first contraction portion 40. Thus, the formation range of the second flame 38B is reduced (moved to the upstream side) as compared with the case of the comparative example described above with reference to FIGS. 5 and 6, and the consumption of carbon monoxide contained in the combustion gas is promoted. Thus, the concentration of carbon monoxide is reduced at the downstream end L_{end} of the cylinder 24. As a result, the load range that can be operated is extended while keeping the concentration of carbon monoxide at the downstream end L_{end} below the reference value, so that the turndown performance (low load operation performance) can be improved as compared with the comparative example.

The first contraction portion 40 extends partially along the circumferential direction, as shown in FIGS. 4 and 9. In other words, the first contraction portion 40 has an asymmetrical structure and thus suitably suppresses combustion oscillation that is likely to occur during partial load operation.

Further, the first contraction portion 40 may include a plurality of contraction pieces arranged at intervals along the circumferential direction. Since the temperature of the first contraction portion 40 rises due to receiving the combustion gas flowing inside the cylinder 24, cooling air 44 is supplied as a cooling medium (see FIG. 7). Here, as the cooling air 44 is used part of the compressed air supplied from the compressor 2. Therefore, as the cooling air 44 increases, the compressed air mixed with the fuel from the fuel nozzle 22 and used for producing the combustion gas decreases, which may result in an increase in NOx emissions. Then, in the present embodiment, the first contraction portion 40 is divided into a plurality of contraction pieces 40a. With this configuration, the heat capacity of the first contraction portion 40 can be reduced, and the temperature rise of the first contraction portion 40 can be suppressed with a small amount of cooling air 44. As a result, the compressed air mixed with the fuel from the fuel nozzle 22 and used for producing the combustion gas can be sufficiently secured, and NOx emissions can be reduced.

These contraction pieces 40a are arranged between the fuel nozzles 22B adjacent along the circumferential direction when viewed from the axial direction, as in FIG. 4. At such positions, the temperature of the combustion gas tends to be lower than at the position overlapping the fuel nozzle 22B. Therefore, when the first contraction portion 40 causes the hot gas at the radially inner side and the hot gas at the central position of the fuel nozzle to flow downstream of the contraction, the temperature rise of the combustion gas can be effectively promoted.

Further, as shown in FIG. 9, these contraction pieces 40a may be integrally formed by being connected to each other by a connection member 40b extending along the circumferential direction. This facilitates the attachment of the first contraction portion 40 to the inner peripheral surface of the cylinder 24.

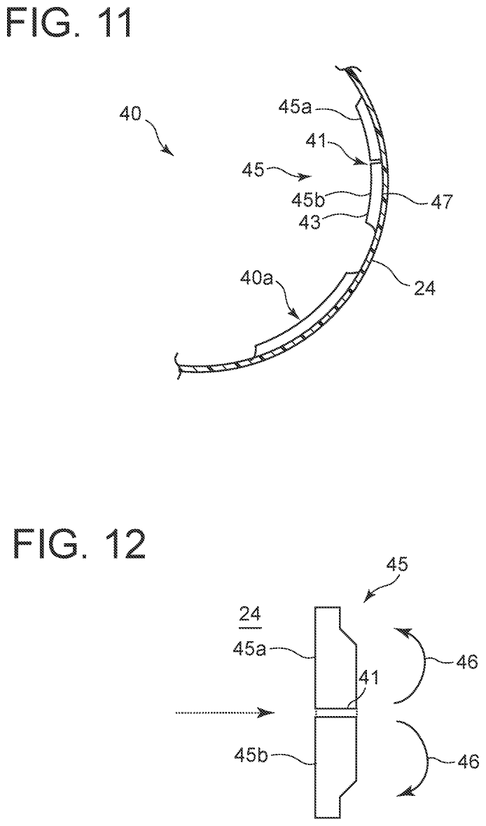

The plurality of contraction pieces 40a constituting the first contraction portion 40 may include a grooved contraction piece 45 having a groove portion 41. FIG. 11 is a diagram showing an example of the first contraction portion 40 including a grooved contraction piece FIG. 12 is a diagram showing the grooved contraction piece 45 of FIG. 11 together with the flow of combustion gas from the radially inner side.

Although FIGS. 11 and 12 illustrate the case where the first contraction portion 40 is composed of a plurality of contraction pieces 40a which are independent members (separate members), the contraction pieces 40a may be connected by the connection member 40b as shown in FIG. 9. Further, although FIG. 11 shows the case where some of the plurality of contraction pieces 40a of the first contraction portion 40 are configured as the grooved contraction piece 45, the proportion of the grooved contraction piece 45 in the plurality of contraction pieces 40a may be any proportion. All contraction pieces 40a may be the grooved contraction pieces 45, or all contraction pieces 45 may be groove-less contraction pieces as in the above-described embodiments.

The grooved contraction piece 45 has a groove portion 41 formed so as to extend radially outward from the radially inner edge 43. In the present embodiment, since the groove portion 41 extends from the radially inner edge 43 to the radially outer edge 47, the grooved contraction piece 45 is divided into a first piece member 45a and a second piece member 45b. By configuring the grooved contraction piece 45 as a combination of small members in this way, it can be easily attached to the cylinder.

The groove portion 41 may be configured as a recess that is partially cut radially outward from the radially inner edge 43 (that is, does not reach the radial outer edge 47). In this case, the grooved contraction piece 45 has a configuration in which the first piece member and the second piece member 45b are partially connected.

When the combustion gas received by the first contraction portion 40 from the upstream side passes through the groove portion 41 of the grooved contraction piece 45, vortices 46 are formed downstream of the grooved contraction piece 45 as shown in FIG. 12. The vortices 46 are formed so as to swirl in the in-plane direction in a cross-section perpendicular to the axial direction of the cylinder 24. The vortices 46 agitate the combustion gas inside the cylinder 24 and promote combustion.

The shape and size of the groove portion 41 can be set freely, but if the groove portion 41 is too large, the combustion promotion effect by deflection of the combustion gas in the radial direction by the first contraction portion 40 as described above decreases, while if the groove portion 41 is too small, the combustion promotion effect by the vortex 46 formed by the groove portion 41 decreases. Therefore, the shape and size are preferably determined in consideration of the balance. It is preferable that the size of the groove portion 41 is sufficiently small relative to the arrangement interval (pitch) of the plurality of fuel nozzles 22 in the circumferential direction, and may be set to, for example, the contraction height or less.

The groove portion 41 is disposed at a substantially central position of the grooved contraction piece 45 along the circumferential direction. By setting the position of the groove portion 41 in this way, the vortex 46 for promoting combustion can be effectively generated.

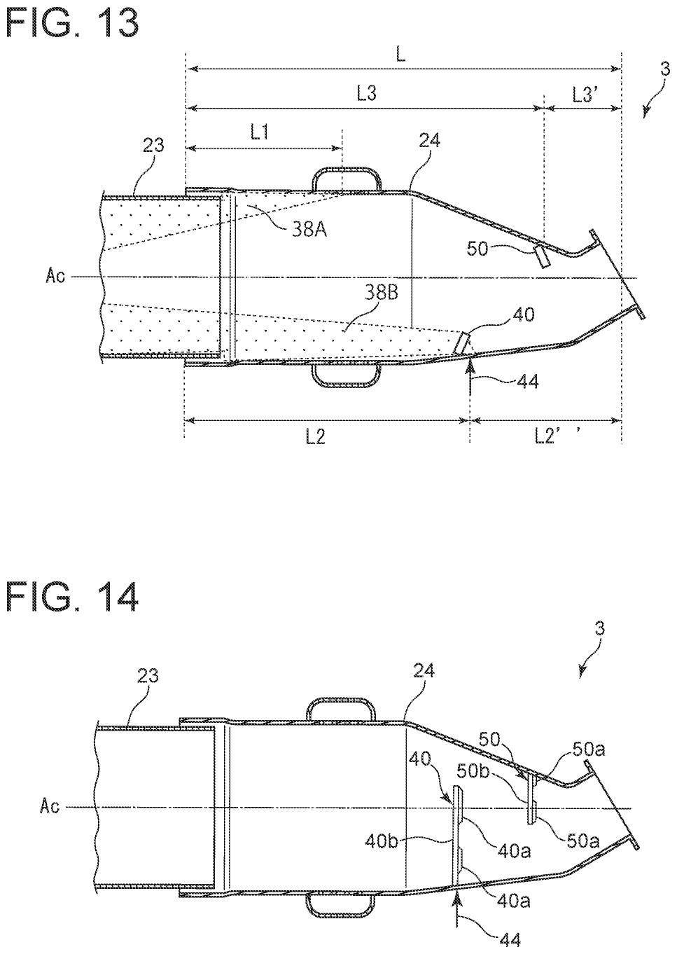

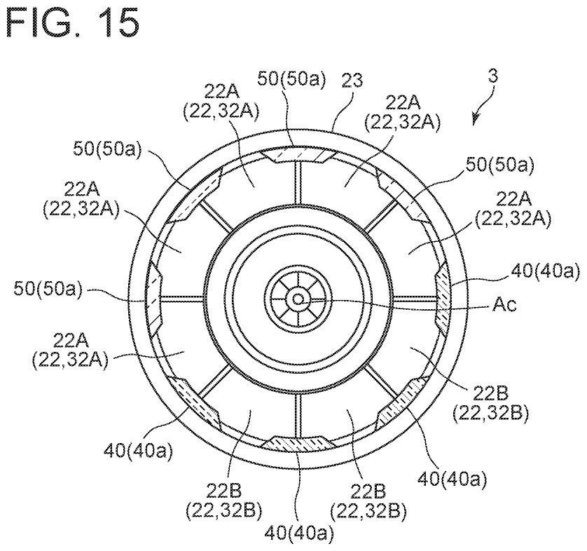

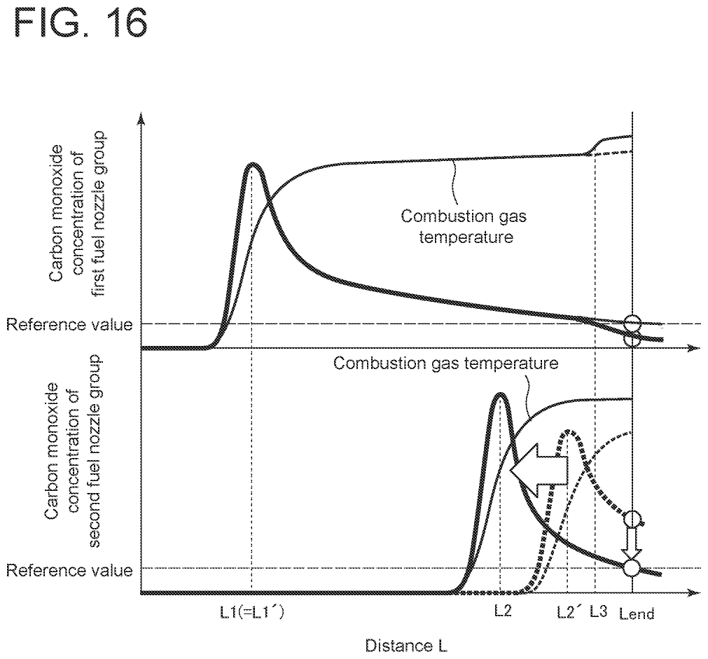

FIG. 13 is a modified example of FIG. 7. FIG. 14 is a side view of the cylinder 24 with the first contraction portion 40 and the second contraction portion 50 of FIG. 13 transparently shown. FIG. 15 is a schematic diagram of the fuel nozzles 22 of FIG. 13 viewed from the downstream side along the combustor axis Ac. FIG. 16 is a diagram showing distributions of temperature and carbon monoxide concentration corresponding to FIG. 13.

The combustor 3 according to this modification includes, in addition to the first contraction portion 40, a second contraction portion 50. The second contraction portion 50 extends along the circumferential direction so as to correspond to the other of the first fuel nozzle group 32A or the second fuel nozzle group 32B. In this modification, since the first contraction portion 40 is disposed corresponding to the second fuel nozzle group 32B, the second contraction portion 50 is disposed corresponding to the first fuel nozzle group 32A. Specifically, the first contraction portion 40 corresponding to the second fuel nozzle group 32B which is controlled to have small fuel injection amount during partial load operation of the combustor 3 is disposed upstream of the second contraction portion 50 corresponding to the first fuel nozzle group 32A which is controlled to have large fuel injection amount.

Since the fuel injection amount of the fuel nozzle 22B belonging to the second fuel nozzle group 32B is smaller than that of the fuel nozzle 22A belonging to the first fuel nozzle group 32A, as shown in FIG. 13, the formation range of the second flame is wide, and the combustion temperature is relatively low, so that carbon monoxide is easily generated as compared with the first fuel nozzle group 32A. Therefore, when the first contraction portion 40 corresponding to the second fuel nozzle group 32B is arranged upstream of the second contraction portion 50 corresponding to the first fuel nozzle group 32A, the combustion gas near the inner peripheral surface can flow toward the central position in the vicinity of the fuel nozzle. As a result, the combustion of the combustion gas in the second fuel nozzle group 32B can be further promoted, and carbon monoxide emitted from the combustion gas can be effectively reduced.

The second contraction portion 50 has substantially the same shape as the first contraction portion 40 described with reference to FIG. 8 and is formed so as to protrude radially inward from the inner peripheral surface of the cylinder 24. Thereby, the combustion gas near the inner peripheral surface where the second contraction portion 50 is disposed flows toward the radially inner side of the cylinder 24 where the temperature is relatively high. As a result, combustion of the combustion gas corresponding to the other, i.e., the first fuel nozzle group 32A, can also be promoted, and carbon monoxide contained in the combustion gas can be reduced more effectively. FIG. 16 indicates that, in the vicinity of the distance L3 where the second contraction portion 50 is disposed, the combustion gas temperature in the first fuel nozzle group 32A further rises, and the concentration of carbon monoxide contained in the combustion gas is further reduced (In FIG. 16, the relative positions of the distances L1, L1′, L2, L2′, and L3 are appropriately changed from the other drawings for clarity of illustration).

The second contraction portion 50 extends partially along the circumferential direction on the inner surface of the cylinder 24 like the first contraction portion 40, but as shown in FIGS. 13 and 14, the first contraction portion 40 and the second contraction portion are disposed at different axial positions to form an asymmetrical structure. Therefore, even when the second contraction portion 50 is additionally provided in addition to the first contraction portion 40, combustion oscillation during partial load operation can be effectively suppressed.

The first contraction portion 40 and the second contraction portion 50 are disposed so as to have equal ratio of a distance to the downstream end L_{end} of the cylinder 24 and an oxidation rate of CO contained in the combustion gas. More specifically, the distance L2 from the upstream end of the cylinder 24 to the first contraction portion 40, the CO oxidation rate V2 in the fuel nozzle 22B belonging to the second fuel nozzle group 32B corresponding to the first contraction portion 40, the distance L3 from the upstream end of the cylinder 24 to the second contraction portion 50, and the CO oxidation rate V1 in the fuel nozzle 22A belonging to the first fuel nozzle group 32A corresponding to the second contraction portion 50 are designed so as to satisfy the following equation (L2″=L−L2, L3″=L−L3, where L is the entire length of the cylinder 24).

L2″/V1=L3″/V2

By arranging the first contraction portion 40 and the second contraction portion 50 in such a positional relationship, carbon monoxide contained in the combustion gas from each fuel nozzle 22 belonging to the first fuel nozzle group 32A and the second fuel nozzle group 32B can be effectively reduced.

Further, the second contraction portion 50 may include a plurality of contraction pieces 50a arranged at intervals along the circumferential direction, like the first contraction portion 40. When the second contraction portion 50 is divided into a plurality of contraction pieces 50a, the heat capacity of the second contraction portion 50 can be reduced, and the temperature rise of the second contraction portion 50 can be suppressed with a small amount of cooling air 44. Thus, also in the first fuel nozzle group 32A, the compressed air mixed with the fuel from the fuel nozzle 22 and used for producing the combustion gas can be sufficiently secured, and NOx emissions can be reduced.

These contraction pieces 50a are arranged between the fuel nozzles 22A adjacent along the circumferential direction when viewed from the axial direction, as in FIG. 15. At such positions, the temperature of the combustion gas tends to be lower than at the position overlapping the fuel nozzle 22A. Therefore, when the second contraction portion 50 causes the combustion gas to flow radially inward, the temperature rise of the combustion gas can be effectively promoted.

Further, as shown in FIG. 15, these contraction pieces 50a may be integrally formed by being connected to each other by a connection member 50b extending along the circumferential direction. This facilitates the attachment of the second contraction portion 50 to the inner peripheral surface of the cylinder 24.

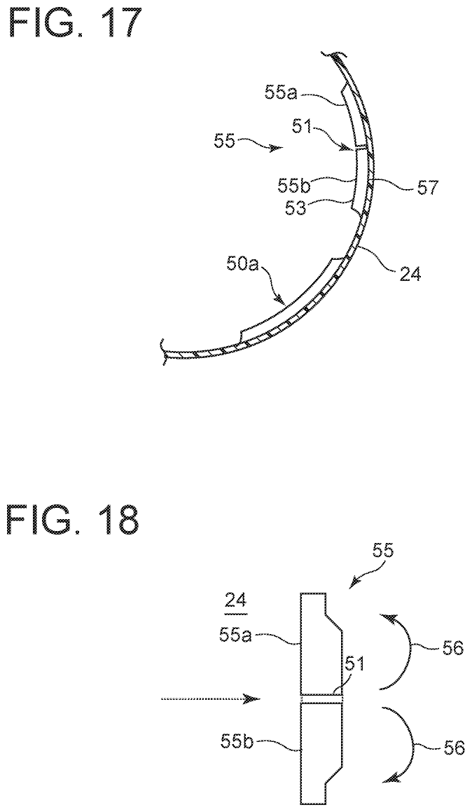

The plurality of contraction pieces 50a constituting the second contraction portion 50 may include a grooved contraction piece 55 having a groove portion 51. FIG. 17 is a diagram showing an example of the second contraction portion 50 including a grooved contraction piece 55. FIG. 18 is a diagram showing the grooved contraction piece 55 of FIG. 17 together with the flow of combustion gas from the radially inner side.

Although FIGS. 17 and 18 illustrate the case where the second contraction portion 50 is composed of a plurality of contraction pieces 50a which are independent members (separate members), the contraction pieces 50a may be connected by the connection member 50b as shown in FIG. 15. Further, although FIG. 17 shows the case where some of the plurality of contraction pieces 50a of the second contraction portion 50 are configured as the grooved contraction piece 55, the proportion of the grooved contraction piece 55 in the plurality of contraction pieces 50a may be any proportion. All contraction pieces 50a may be the grooved contraction pieces 55, or all contraction pieces 55 may be groove-less contraction pieces as in the above-described embodiments.

The grooved contraction piece 55 has a groove portion 51 formed so as to extend radially outward from the radially inner edge 53. In the present embodiment, since the groove portion 51 extends from the radially inner edge 53 to the radially outer edge 57, the grooved contraction piece 55 is divided into a first piece member 55a and a second piece member 55b. By configuring the grooved contraction piece 55 as a combination of small members in this way, it can be easily attached to the cylinder.

The groove portion 51 may be configured as a recess that is partially cut radially outward from the radially inner edge 53 (that is, does not reach the radial outer edge 57). In this case, the grooved contraction piece 55 has a configuration in which the first piece member and the second piece member 55b are partially connected.

When the combustion gas received by the second contraction portion 50 from the upstream side passes through the groove portion 51 of the grooved contraction piece 55, vortices 56 are formed downstream of the grooved contraction piece 55 as shown in FIG. 18. The vortices 56 are formed so as to swirl in the in-plane direction in a cross-section perpendicular to the axial direction of the cylinder 24. The vortices 56 agitate the combustion gas inside the cylinder 24 and promote combustion.

The shape and size of the groove portion 51 can be set freely, but if the groove portion 51 is too large, the combustion promotion effect by deflection of the combustion gas in the radial direction by the second contraction portion 50 as described above decreases, while if the groove portion 51 is too small, the combustion promotion effect by the vortex 56 formed by the groove portion 51 decreases. Therefore, the shape and size are preferably determined in consideration of the balance. It is preferable that the size of the groove portion 51 is sufficiently small relative to the arrangement interval (pitch) of the plurality of fuel nozzles 22 in the circumferential direction, and may be set to, for example, the contraction height or less.

The groove portion 51 is disposed at a substantially central position of the grooved contraction piece 55 along the circumferential direction. By setting the position of the groove portion 51 in this way, the vortex 56 for promoting combustion can be effectively generated.

As described above, according to the above-described embodiments, it is possible to provide the combustor 3 of the gas turbine 1 that can suitably suppress the generation of carbon monoxide while preventing combustion oscillation during partial load operation.

In addition, the components in the above-described embodiments may be appropriately replaced with known components without departing from the spirit of the present disclosure, or the above-described embodiments may be appropriately combined.

The contents described in the above embodiments would be understood as follows, for instance.

(1) A combustor for a gas turbine according to an aspect includes: a first fuel nozzle group and a second fuel nozzle group each of which includes a fuel nozzle capable of supplying a fuel and has an independently controllable fuel supply system; a cylinder inside which a combustion region allowing a combustion gas produced by combustion of the fuel to flow is formed; and a first contraction portion extending partially along a circumferential direction so as to correspond to one of the first fuel nozzle group or the second fuel nozzle group and protruding radially inward from an inner peripheral surface of the cylinder.

According to the above aspect (1), the first contraction portion protruding radially inward is formed on the inner peripheral surface of the cylinder so as to correspond to one of the first fuel nozzle group or the second fuel nozzle group. Thereby, the combustion gas near the inner peripheral surface where the first contraction portion is disposed is deflected toward the radially inner side of the cylinder where the temperature is relatively high, so that the combustion is promoted, and carbon monoxide is effectively reduced. Further, since the first contraction portion extends partially along the circumferential direction to form an asymmetrical structure, combustion oscillation is less likely to occur during partial load operation. Thus, it is possible to achieve the gas turbine that can suitably suppress the generation of carbon monoxide while preventing combustion oscillation during partial load operation.

(2) In another aspect, in the above aspect (1), the first contraction portion includes a plurality of contraction pieces arranged at intervals along the circumferential direction.

According to the above aspect (2), the first contraction portion includes a plurality of contraction pieces. The first contraction portion may be supplied with cooling air to suppress the temperature rise due to heat received from the combustion gas when it deflects the combustion gas. In the present aspect, since the first contraction portion is divided into a plurality of contraction pieces, the heat capacity of the first contraction portion can be reduced, and the temperature rise can be suppressed with a small amount of cooling air.

(3) In another aspect, in the above aspect (2), the plurality of contraction pieces are arranged between the fuel nozzles that are adjacent along the circumferential direction when viewed from an axial direction.

According to the above aspect (3), the contraction pieces constituting the first contraction portion are arranged between the fuel nozzles adjacent along the circumferential direction when viewed from the axial direction. Since such positions have relatively low temperature compared with the position overlapping the fuel nozzle, the temperature rise in the first contraction portion can be effectively suppressed.

(4) In another aspect, in the above aspect (2) or (3), the plurality of contraction pieces are connected to each other by a connection member extending along the circumferential direction.

According to the above aspect (4), the contraction pieces constituting the first contraction portion are integrally formed by being connected to each other by the connection member extending along the circumferential direction. This facilitates the attachment of the first contraction portion to the inner peripheral surface of the cylinder.

(5) In another aspect, in any one of the above aspects (1) to (4), the plurality of contraction pieces includes a grooved contraction piece having a groove portion formed radially outward from a radially inner edge of the contraction piece.

According to the above aspect (5), at least some of the plurality of contraction pieces of the first contraction portion are configured as the grooved contraction piece. The grooved contraction piece has the groove portion formed radially outward from the radially inner edge. The groove portion forms a vortex downstream of the contraction piece when the combustion gas received by the contraction piece passes therethrough, which effectively promotes combustion.

(6) In another aspect, in the above aspect (5), the grooved contraction piece includes a first piece member and a second piece member divided from each other by the groove portion.

According to the above aspect (6), the grooved contraction piece has a configuration in which the first piece member and the second piece member are divided from each other by the groove portion. By configuring the grooved contraction piece as a combination of small members in this way, it can be easily attached to the cylinder. Further, since a sufficient groove portion can be formed between the first piece member and the second piece member, the vortex formed by the groove portion can be made large, and combustion can be further promoted.

(7) In another aspect, in the above aspect (5) or (6), the groove portion is disposed at a substantially central position of the grooved contraction piece along the circumferential direction.

According to the above aspect (7), since the groove portion is provided at the substantially central position of the groove contraction piece along the circumferential direction, the vortex for promoting combustion can be effectively generated.

(8) In another aspect, in any one of the above aspects (1) to (7), the combustor further includes a second contraction portion extending partially along the circumferential direction so as to correspond to the other of the first fuel nozzle group or the second fuel nozzle group and protruding radially inward from the inner peripheral surface of the cylinder. The first contraction portion and the second contraction portion are disposed at different axial positions.

According to the above aspect (8), in addition to the first contraction portion, the second contraction portion is provided so as to correspond to the other of the first fuel nozzle group or the second fuel nozzle group. The second contraction portion protrudes radially inward like the first contraction portion and defects the combustion gas radially inward in the vicinity of the inner peripheral surface of the cylinder where the second contraction portion is disposed. As a result, the combustion of the combustion gas can also be promoted on the other side, and carbon monoxide can be effectively reduced. Further, the second contraction portion extends partially along the circumferential direction at a different axial position from the first contraction portion to form an asymmetrical structure. Therefore, even when the second contraction portion is additionally provided in addition to the first contraction portion, combustion oscillation during partial load operation can be effectively suppressed.

(9) In another aspect, in the above aspect (8), the second contraction portion includes a plurality of contraction pieces arranged at intervals along the circumferential direction.

According to the above aspect (9), the second contraction portion includes a plurality of contraction pieces. The second contraction portion may be supplied with cooling air to suppress the temperature rise due to receiving the combustion gas flowing inside the cylinder, like the first contraction portion described above. In the present aspect, since the second contraction portion is divided into a plurality of contraction pieces, the heat capacity of the second contraction portion can be reduced, and the temperature rise can be suppressed with a small amount of cooling air.

(10) In another aspect, in the above aspect (9), the plurality of contraction pieces are arranged between the fuel nozzles that are adjacent along the circumferential direction when viewed from an axial direction.

According to the above aspect (10), the contraction pieces constituting the second contraction portion are arranged between the fuel nozzles adjacent along the circumferential direction when viewed from the axial direction, like the first contraction portion described above. Since such positions have relatively low temperature compared with the position overlapping the fuel nozzle, the temperature rise in the second contraction portion can be effectively suppressed.

(11) In another aspect, in the above aspect (9) or (10), the plurality of contraction pieces are connected to each other by a connection member extending along the circumferential direction.

According to the above aspect (11), the contraction pieces constituting the second contraction portion are integrally formed by being connected to each other by the connection member extending along the circumferential direction like the first contraction portion described above. This facilitates the attachment of the second contraction portion to the inner peripheral surface of the cylinder.

(12) In another aspect, in any one of the above aspects (9) to (11), the plurality of contraction pieces includes a grooved contraction piece having a groove portion formed radially outward from a radially inner edge of the contraction piece.

According to the above aspect (12), at least some of the plurality of contraction pieces of the second contraction portion are configured as the grooved contraction piece. The grooved contraction piece has the groove portion formed radially outward from the radially inner edge. The groove portion forms a vortex downstream of the contraction piece when the combustion gas received by the contraction piece passes therethrough, which effectively promotes combustion.

(13) In another aspect, in the above aspect (12), the grooved contraction piece includes a first piece member and a second piece member divided from each other by the groove portion.

According to the above aspect (13), the grooved contraction piece has a configuration in which the first piece member and the second piece member are divided from each other by the groove portion. By configuring the grooved contraction piece as a combination of small members in this way, it can be easily attached to the cylinder. Further, since a sufficient groove portion can be formed between the first piece member and the second piece member, the vortex formed by the groove portion can be made large, and combustion can be further promoted.

(14) In another aspect, in the above aspect (12) or (13), the groove portion is disposed at a substantially central position of the grooved contraction piece along the circumferential direction.

According to the above aspect (14), since the groove portion is provided at the substantially central position of the groove contraction piece along the circumferential direction, the vortex for promoting combustion can be effectively generated.

(15) In another aspect, in any one of the above aspects (8) to (14), the fuel injection amount of the fuel nozzle included in the first fuel nozzle group is controlled to be larger than that of the fuel nozzle included in the second fuel nozzle group during partial load operation. The first contraction portion is disposed so as to correspond to the second fuel nozzle group, and the second contraction portion is disposed so as to correspond to the first fuel nozzle group. The first contraction portion is disposed upstream of the second contraction portion.

According to the above aspect (15), the first contraction portion corresponding to the second fuel nozzle group is disposed upstream of the second contraction portion corresponding to the first fuel nozzle group. Since the fuel injection amount of the fuel nozzle belonging to the second fuel nozzle group is smaller than that of the fuel nozzle belonging to the first fuel nozzle group, the formation range of the flame is wide, and the combustion temperature is relatively low, so that carbon monoxide is easily generated as compared with the fuel nozzle belonging to the first fuel nozzle group. Therefore, when the first contraction portion corresponding to the second fuel nozzle group is arranged upstream of the second contraction portion corresponding to the first fuel nozzle group, the combustion gas near the inner peripheral surface can be deflected toward the central position in the vicinity of the fuel nozzle, so that combustion can be promoted, and carbon monoxide can be reduced.

(16) In another aspect, in any one of the above aspects (8) to (15), the first contraction portion and the second contraction portion are disposed so as to have equal ratio of a distance from an upstream end of the cylinder and an oxidation rate of CO contained in the combustion gas.

According to the above aspect (16), by arranging the first contraction portion and the second contraction portion in such a positional relationship, carbon monoxide contained in the combustion gas from each fuel nozzle belonging to the first fuel nozzle group and the second fuel nozzle group can be effectively reduced.

(17) A gas turbine according to an aspect includes the combustor according to any one of the above aspects (1) to (16).

According to the above aspect (17), since the combustor having the above configuration is included, it is possible to achieve the gas turbine that can suitably suppress the generation of carbon monoxide while preventing combustion oscillation during partial load operation.

### REFERENCE SIGNS LIST

1 Gas turbine
2 Compressor
3 Combustor
5 Turbine
6 Compressor rotor
7 Compressor casing
8 Compressor rotor blade
9 Compressor rotor blade stage
10 Compressor stator vane
11 Compressor stator vane stage
12 Turbine rotor
13 Turbine casing
14 Turbine rotor blade
15 Turbine rotor blade stage
16 Turbine stator vane
17 Turbine stator vane stage
18 Gas turbine rotor
19 Gas turbine casing
20 Generator
21 Combustor casing
22 Fuel nozzle
23 Swirler support pipe
24 Cylinder
30A First fuel supply system
30B Second fuel supply system
32A First fuel nozzle group
32B Second fuel nozzle group
34A First fuel supply passage
34B Second fuel supply passage
36A First fuel flow-rate adjustment valve
36B Second fuel flow-rate adjustment valve
38A First flame
38B Second flame
40 First contraction portion
40a Contraction piece
40b Connection member
41 Groove portion
43 Radially inner edge
45 Grooved contraction piece
45a First piece member
45b Second piece member
46 Vortex
47 Radially outer edge
50 Second contraction portion
50a Contraction piece
50b Connection member
51 Groove portion
53 Radially inner edge
55 Grooved contraction piece
55a First piece member
55b Second piece member
56 Vortex
57 Radially outer edge

1. A combustor for a gas turbine, comprising:
a first fuel nozzle group and a second fuel nozzle group each of which includes a fuel nozzle capable of supplying a fuel and has an independently controllable fuel supply system;
a cylinder inside which a combustion region allowing a combustion gas produced by combustion of the fuel to flow is formed; and
a first contraction portion extending partially along a circumferential direction so as to correspond to one of the first fuel nozzle group or the second fuel nozzle group and protruding radially inward from an inner peripheral surface of the cylinder.

2. The combustor for a gas turbine according to claim 1, wherein the first contraction portion includes a plurality of contraction pieces arranged at intervals along the circumferential direction.

3. The combustor for a gas turbine according to claim 2, wherein the plurality of contraction pieces are arranged between the fuel nozzles that are adjacent along the circumferential direction when viewed from an axial direction.

4. The combustor for a gas turbine according to claim 2, wherein the plurality of contraction pieces are connected to each other by a connection member extending along the circumferential direction.

5. The combustor for a gas turbine according to claim 2, wherein the plurality of contraction pieces includes a grooved contraction piece having a groove portion formed radially outward from a radially inner edge of the contraction piece.

6. The combustor for a gas turbine according to claim 5, wherein the grooved contraction piece includes a first piece member and a second piece member divided from each other by the groove portion.

7. The combustor for a gas turbine according to claim 5, wherein the groove portion is disposed at a substantially central position of the grooved contraction piece along the circumferential direction.

8. The combustor for a gas turbine according to claim 1, further comprising:
a second contraction portion extending partially along the circumferential direction so as to correspond to the other of the first fuel nozzle group or the second fuel nozzle group and protruding radially inward from the inner peripheral surface of the cylinder, wherein
the first contraction portion and the second contraction portion are disposed at different axial positions.

9. The combustor for a gas turbine according to claim 8, wherein the second contraction portion includes a plurality of contraction pieces arranged at intervals along the circumferential direction.

10. The combustor for a gas turbine according to claim 9, wherein the plurality of contraction pieces are arranged between the fuel nozzles that are adjacent along the circumferential direction when viewed from an axial direction.

11. The combustor for a gas turbine according to claim 9, wherein the plurality of contraction pieces are connected to each other by a connection member extending along the circumferential direction.

12. The combustor for a gas turbine according to claim 9, wherein the plurality of contraction pieces includes a grooved contraction piece having a groove portion formed radially outward from a radially inner edge of the contraction piece.

13. The combustor for a gas turbine according to claim 12, wherein the grooved contraction piece includes a first piece member and a second piece member divided from each other by the groove portion.

14. The combustor for a gas turbine according to claim 12, wherein the groove portion is disposed at a substantially central position of the grooved contraction piece along the circumferential direction.

15. The combustor for a gas turbine according to claim 8, wherein
fuel injection amount of the fuel nozzle included in the first fuel nozzle group is controlled to be larger than that of the fuel nozzle included in the second fuel nozzle group during partial load operation,
the first contraction portion is disposed so as to correspond to the second fuel nozzle group,
the second contraction portion is disposed so as to correspond to the first fuel nozzle group, and
the first contraction portion is disposed upstream of the second contraction portion.

16. The combustor for a gas turbine according to claim 8, wherein the first contraction portion and the second contraction portion are disposed so as to have equal ratio of a distance from an upstream end of the cylinder and an oxidation rate of CO contained in the combustion gas.

17. A gas turbine, comprising the combustor according to claim 1.
